(19) United States
(12) Patent Application Publication
(10) Pub. No.: US 2022/0004677 A1
(43) Pub. Date: Jan. 6, 2022

(54) MECHANICAL PRODUCT PERSONALIZED DESIGN PATTERN MATCHING METHOD ORIENTED TO INTERNET + ENVIRONMENT

(71) Applicant: ZHEJIANG UNIVERSITY, Hangzhou City (CN)

(72) Inventors: Shuyou ZHANG, Hangzhou City (CN); Lemiao QIU, Hangzhou City (CN); Zili WANG, Hangzhou City (CN); Ye GU, Hangzhou City (CN)

(21) Appl. No.: 17/475,288

(22) Filed: Sep. 14, 2021

Related U.S. Application Data
(63) Continuation of application No. PCT/CN2021/070982, filed on Jan. 8, 2021.

(51) Int. Cl. G06F 30/17; G06F 17/18

(52) U.S. Cl. CPC G06F 30/17; G06F 2111/20; G06F 17/18

(57) ABSTRACT

Provided is a mechanical product personalized design pattern matching method oriented to an Internet+ environment. According to the method, a user order is quantified into a feature vector, a mechanical product is decomposed into modules, a historical case library is constructed, and a design pattern scheme matched according to the user order is obtained according to the probability that a user is satisfied when different design patterns are adopted by respective modules of the mechanical product. From the perspective of probability, a personalized design pattern matching method of each design module in product customization design is researched according to the Bayesian theorem.

### CROSS-REFERENCE TO RELATED APPLICATIONS

The present application is a continuation of International Application No. PCT/CN2021/070982, filed on Aug. 1, 2021, which claims priority to Chinese Application No. 202010640643.8, filed on Jul. 6, 2020, the contents of both of which are incorporated herein by reference in their entireties.

### TECHNICAL FIELD

The present application belongs to the field of customized design of a mechanical product, and in particular relates to a matching method for personalized design patterns of a mechanical product oriented to an Internet+ environment.

### BACKGROUND

Experts predict that more than half of the products in the future will be customized and personalized products. With the continuous improvement of industrial technology and people's living standards, material needs are becoming more and more extensive, and traditional single products can no longer meet people's individualized needs. Traditional product customization design patterns and batch production lines can no longer satisfy the design and production of customized products. The design pattern of mass customization is to preset product modules and module families, configure product modules according to user's needs, and combine products that meet user's needs. However, with the increasing individualization of demands, the source of product orders is slowly changed from groups to individual users, and the design pattern of mass customization will be difficult to meet the needs of users. Existing product modules and module families can't fully cover the individual needs of users, and the module library cannot be updated in advance because the future demand trend cannot be predicted accurately. At the same time, the design pattern of mass customization cannot adapt to complex customized mechanical products or equipment.

### SUMMARY

In view of the shortcomings of the prior art, the purpose of the present application is to provide a matching method for personalized design patterns of a mechanical product oriented to an Internet+ environment.

The purpose of the present application is realized by the following technical solution: a matching method for personalized design patterns of a mechanical product oriented to an Internet+ environment, comprising the following steps:

(1) constructing an order feature vector order of a personalized demand of a user:

order={(req₁,r₁),(req₂,r₂), . . . ,(reqᵢ,rᵢ), . . . ,(reqₙ,rₙ)}

where, reqᵢ represents an i^{th} demand feature, rᵢ represents a normalized demand value of the i^{th} demand feature, n is a number of demand features;

(2) decomposing a mechanical product into m modules d₁˜dₘ and constructing a product decomposition module set D={d₁, d₂, . . . dₘ};

(3) constructing a design pattern matching case library X according to historical order records of a design pattern scheme that meets the demand of the user:

X={(orderⱼ,patternⱼ)}ⱼ₌₁^{M}

patternⱼ={p₁ⱼ,p₂ⱼ, . . . ,pₖⱼ, . . . ,pₘⱼ}

where, M represents a number of historical orders in the design pattern matching case library, orderⱼ represents an order feature vector of a j^{th} order; pₖⱼ represents a design pattern adopted by a k^{th} module in the j^{th} order, patternⱼ represents a design pattern matching result of each module in the j^{th} order, 1≤k≤m;

(4) for a new order feature vector order*, when the k^{th} module of the mechanical product adopts different design patterns, a user satisfaction probability order* being:

$$P ( {ɛ}_{k} \vert o r d e {r}^{*} ) = \frac{P ( {ɛ}_{k} ) P ( {order}^{*} \vert {ɛ}_{k} )}{P ( {order}^{*} )}$$

where, 0<P(order*)≤1 is a constant; P(εₖ) represents a probability that the k^{th} module in the design pattern matching case library X adopts a design pattern εₖ:

$$P ( {ɛ}_{k} ) = \frac{\vert X ( {ɛ}_{k} ) \vert}{M}$$

where, X(εₖ) represents an order set in which the k^{th} module in X adopts the design pattern εₖ, |X(εₖ)| is a number of elements in X(εₖ); P(order*|εₖ) is a conditional probability of selecting different design patterns for the k^{th} module according to the new order feature vector order*:

$$P ( o r d e {r}^{*} \vert {ɛ}_{k} ) = {\prod }_{i = 1}^{n} P ( {r}_{i}^{*} \vert {ɛ}_{k} ) = {\prod }_{i = 1}^{n} \frac{1}{\sqrt{2 π} {σ}_{{ɛ}_{k} , i}} exp ( - \frac{{( {r}_{i}^{*} - {μ}_{{ɛ}_{k} , i} )}^{2}}{2 {σ}_{{ɛ}_{k} , i}^{2}} )$$

where, rᵢ* represents a normalized demand value of the i^{th} demand feature in order*, 1≤i≤n; X(εₖ)ᵢ is a set of normalized demand values rᵢ of the i^{th} demand feature in an order where the k^{th} module in X adopts the design pattern εₖ, and μ_{ε}_{ₖ}_{,i}, σ_{ε}_{ₖ}_{,i}² are a mean value and a variance of the set respectively;

(5) taking the design pattern corresponding to a maximum probability value of P(εₖ|order*) as a design pattern matching result pₖ* of the k^{th} module; wherein, comparing a value of {P(εₖ|order*)|εₖ=1, 2, 3} is actually comparing a value of {P(εₖ)P(order*|εₖ)|εₖ=1, 2, 3} since P(order*) is a constant; and

(6) obtaining the design pattern matching results of all modules of the mechanical product to form a final design pattern matching result pattern*={p₁*, p₂*, . . . , pₖ*, . . . , pₘ*}.

Furthermore, the design pattern εₖ=1, 2, 3; wherein, εₖ=1 means that the k^{th} module adopts a design pattern of configuration according to orders, εₖ=2 means that the k^{th} module adopts a design pattern of deformation according to orders, and εₖ=3 means that the kth module adopts a design pattern of generation according to orders.

The present application has the following beneficial effects.

1. In the method of the present application, from the perspective of probability, a personalized design pattern matching method of each design module in product customization design is researched according to the Bayesian theorem; by calculating the user satisfaction probability values of different design patterns adopted by different design modules, the design pattern corresponding to each design module is matched, the trial and error situation when a designer selects the design pattern according to design experience is reduced, and the design efficiency is improved.

2. The intelligence and operability in the personalized design pattern matching process are improved.

### BRIEF DESCRIPTION OF DRAWINGS

FIG. 1 is a flow chart of personalized design of a mechanical product in an Internet+ environment;

FIG. 2 is a flow chart of personalized design pattern matching of a mechanical product in an Internet+ environment; and

FIG. 3 is a process diagram of personalized design of an elevator car system in an Internet+ environment.

### DESCRIPTION OF EMBODIMENTS

The present application will be further described in detail with reference to the drawings and examples.

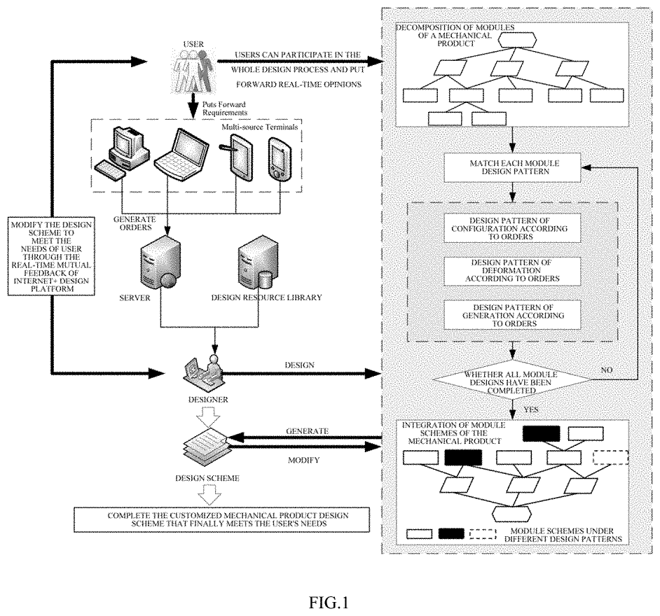

As shown in FIG. 1, it is the flow chart of personalized design of a mechanical product in an Internet+ environment according to the present application, and the steps are as follows:

(1.1) a user puts forward his personalized requirements for the mechanical product through the Internet+ environment constructed by multi-source terminals. The Internet+ design platform converts the user's requirements into product orders, which are transmitted to the designer through a network server.

(1.2) The designer matches the design pattern of each module of the product according to the electronic orders and the matching method for user satisfaction probability of personalized design patterns. The personalized design patterns of the mechanical product in the Internet+ environment includes: a design pattern of configuration according to orders, a design pattern of deformation according to orders and a design pattern of generation according to orders. The specific steps are as follows:

(1) A complex product is decomposed according to design modules which are designed one by one. The design pattern of each module is obtained by matching the order content with a product module library.

(2) The design pattern of configuration according to orders is selected, and the modules meeting the design requirements are matched in the module library according to the product design parameters, configuration rules and configuration templates.

(3) The design pattern of deformation according to orders is selected, the modules to be deformed are located, similar configuration modules are retrieved from the module library, the optimal transplant master and transplant alternative modules are selected, the available structures that meet the design requirements are segmented in terms of structural features, the differences of performance parameters of the master are extracted, the available structures are transplanted (replaced) to the master to reconstruct constraints, and the standard interfaces with adjacent modules are reconstructed, with the performance requirements satisfied, to form a module design scheme of deformation according to orders.

(4) The design pattern of generation according to orders is selected, for the generative design of completely mismatched modules in the module library; constraint conditions, boundary conditions and load conditions are set to generate a variety of generative design results that meet the conditions, and the performance of the generated modules is simulated, and the modules that meet the order requirements are selected as the module design scheme.

(5) Each module is designed one by one, and the design pattern (2)-(4) are adopted. After all the designs are completed, the module schemes of the complex product are merged to generate a customized design scheme of the mechanical product.

(1.3) After the designer completes the design scheme, the user will make real-time mutual feedbacks through the Internet+ platform, and the designer will modify the design scheme until it meets the user's needs; in addition, the user can directly participate in the whole design process, and can put forward change opinions for the designer to make modifications in the process of module successive design. The final design should fully meet the individual needs of user.

The Internet+ design platform is a design platform provided for personalized design of mechanical products in an Internet+ environment. The user and the designer participate in customized design of the products, generally the users put forward or modify requirements, the designer makes customized design according to orders converted from requirements, and the user participates in the whole design process and make feedbacks to the designer in real time to complete products that meet users' needs. Specifically, the pattern matching method for personalized design of a mechanical product oriented to the Internet+ environment includes the following step:

1. In an Internet+ environment, a user submits his demands according to his own personalized demands and generates orders according to preset templates.

2. The customized design process of a mechanical product is completed on an Internet+ design platform. There are three design patterns, namely, design pattern of configuration according to orders, design pattern of deformation according to orders and design pattern of generation according to orders. According to the matching design pattern between the order content and the existing product modules, the designer designs the product modules one by one according to the matching result.

The steps of design pattern of configuration according to orders are as follows.

A1. An individualized order parameter input is converted into mechanical product design parameters.

A2. According to design parameters, configuration structure, configuration rules and configuration modules, suitable modules are matched from the configuration module library to form a customized design scheme of the mechanical product configured according to orders.

A3. The design scheme is transmitted to the user terminal to evaluate whether the scheme meets its own requirements. If so, the customized design scheme of the mechanical product is output to complete the design; otherwise, the design scheme is returned to step 2 for reconfiguration, or the other two design patterns are adopted instead.

The steps of transformation design pattern according to the order are as follows.

B1. An individualized order parameter input is converted into mechanical product design parameters.

B2. In the case that the design pattern of configuration according to orders cannot meet the requirements of the orders, the user feeds back evaluations and requirements in real time to modify the design scheme, and if there are only product modules in the module library that partially meet the design requirements, the design pattern of deformation according to the orders can be adopted.

B3. The product module to be deformed is located and the similar modules are retrieved in the module library.

B4, Similar modules are evaluated, and the optimal transplant module master and transplant alternative modules are selected.

B5. The performance difference between the optimal transplant module master and the design parameters are analyzed, and the available structures in the transplant alternative modules are extracted and segmented.

B6. The segmented available structure in the transplantation alternative modules is transplanted or replaced to the optimal transplantation module master, and structural constraints are reconstructed.

B7. The designer first judges whether the new module meets the performance, if not, it needs to perform structural optimization or return to steps 5-6. If so, the designer will make mutual feedbacks with the user, and steps 4-6 will be repeated, so as to completely meet the user's requirements.

B8. The interface between the new module designed according to the order deformation and the adjacent module is standardized.

B9. Steps 3-8 are repeated to complete the deformation design of other modules, and the customized design scheme of the mechanical product deformed according to the orders is output.

The steps of the design pattern of generation according to orders are as follows.

C1. An individualized order parameter input is converted into mechanical product design parameters.

C2. In the case that the configuration design according to orders and the deformation design according to orders cannot meet the requirements of the orders, the user feeds back evaluations and requirements in real time to modify the design scheme and if there is no product module in the module library that meets the design requirements, the modules can be designed by the design pattern of generation according to orders.

C3. The modules or parts that need to be changed are located, and the product order library is updated according to the order requirements, so as to facilitate the storage of the generative modules in library.

C4. The product design resource library is used to assist the generative design pattern according to orders, constraint requirements, boundary conditions, load conditions and the like are set to generate massive module generative design results.

C5. The designer selects the modules that meet the product performance from the massive generative design modules, transmit them to the user for evaluation, and cooperatively select the modules that fully meet the user's needs; if the user changes the requirements in this process, proceed to step 4.

C6. Steps 3-5 are repeated to complete the generative design of other modules, and form a customized design scheme of the mechanical product generated according to orders.

C7. The generative module models are subjected to modeling of models, documents, structures and rules, and are integrated into the product design resource library.

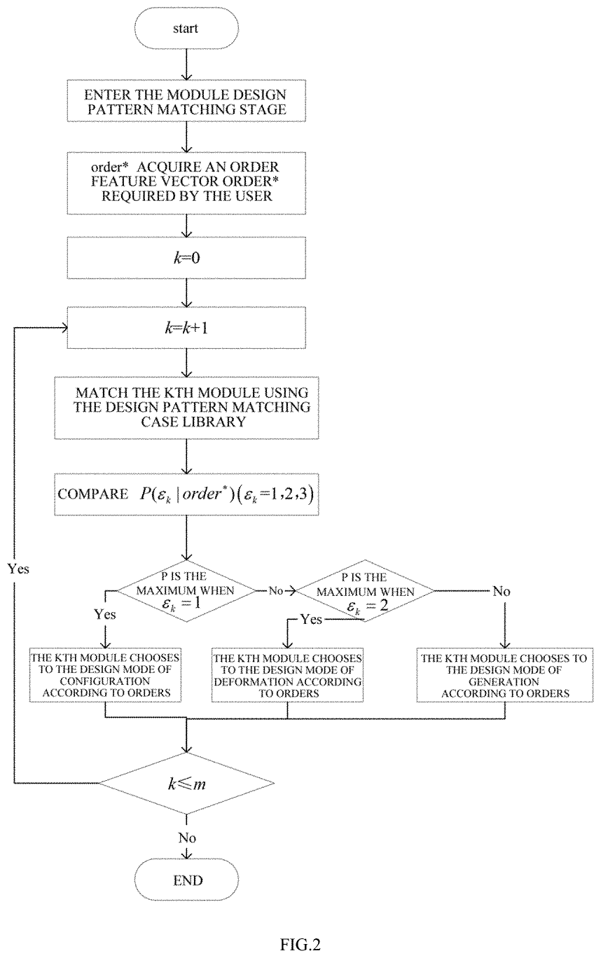

As shown in FIG. 2, it is a flow chart of the matching method for user satisfaction probability of the personalized design pattern in the present application. In the design pattern with the order content matched with the existing product modules, the matching method for user satisfaction probability adopting the personalized design pattern includes the following steps.

2.1. An order feature vector order={(req₁, r₁), (req₂, r₂), . . . , (reqᵢ, rᵢ), . . . , (reqₙ, rₙ)} for the user's personalized requirements is constructed, wherein reqᵢ represents the i^{th} demand feature in the order feature vector, rᵢ represents a corresponding normalized user personalized demand value, n is the number of demand features. For the same kind of mechanical products, the demand features in the feature vectors of different orders are the same, but due to the individualized demand, the normalized demand values r under the same demand features of different orders are different.

2.2. A product decomposition module set D is constructed. The product modules need to be decomposed for each mechanical product before custom design. By the idea of module design, the modules are designed one by one, and the module segmentation results of similar mechanical products are the same D={d₁, d₂, . . . , dₘ}, wherein, dₖ represents the k^{th} module of product segmentation, and there are totally m segmented modules, with 1≤k≤m.

2.3. According to the design case library composed of order records that meet the needs of the user, a design pattern matching case library X={(orderⱼ, patternⱼ)}ⱼ₌₁^{M}, patternⱼ={p₁ⱼ, p₂ⱼ, . . . , pₖⱼ, . . . , pₘⱼ} is constructed, where M represents the number of historical orders in the design pattern matching case library, orderⱼ represents an order feature vector of the j^{th} order; pₖⱼ represents a design pattern adopted by a k^{th} module in the j^{th} order, patternⱼ represents a design pattern matching result of each module in the j^{th} order, 1≤k≤m.

2.4. A new order feature vector order* is input, the user satisfaction probabilities P(εₖ|order*) (εₖ=1, 2, 3) corresponding to the three design patterns of the k^{th} module in D are compared, and the design pattern with the highest user satisfaction probability is selected, including the following sub-steps.

2.4.1 A set {pₖⱼ|j=1˜M} of the design pattern matching results of the k^{th} module in X is found out, and X is divided into X(εₖ), εₖ=1, 2, 3 according to different design patterns in the set, where εₖ indicates the design pattern selected by the k^{th} module, εₖ=1 means that the k^{th} module adopts the design pattern of configuration according to orders, εₖ=2 means that the k^{th} module adopts the design pattern of deformation according to orders, and εₖ=3 means that the k^{th} module adopts the design pattern of generation according to orders; X(εₖ) represents the case set of the k^{th} module adopting design pattern εₖ.

2.4.2 The set of normalized user personalized demand values {rᵢⱼ|j=1˜M} of the i^{th} demand feature in X is found out, and the set is divided into X(εₖ)ᵢ according to X(εₖ) obtained in step 2.4.1, then X(εₖ)ᵢ indicates the set of normalized user personalized demand values of the i^{th} demand feature in the corresponding order record when the k^{th} module adopts the design pattern εₖ.

2.4.3 The probability P(εₖ) that the k^{th} module in X chooses different design patterns εₖ=1, 2, 3 is calculated:

$$P ( {ɛ}_{k} ) = \frac{\vert X ( {ɛ}_{k} ) \vert}{M}$$

where, |X(εₖ)| represents the number of elements in X(εₖ).

2.4.4 The mean value μ_{ε}_{ₖ}_{,i} and the variance σ_{ε}_{ₖ}_{,i}² of the set X(εₖ)ᵢ are calculated.

2.4.5 The conditional probability P(rᵢ*|εₖ) that the k^{th} module chooses different design patterns when the value rᵢ* of the demand feature reqᵢ* in the new order feature vector order* is different is calculated as:

$$P ( {r}_{i}^{*} \vert {ɛ}_{k} ) = \frac{1}{\sqrt{2 π} {σ}_{{ɛ}_{k} , i}} exp ( - \frac{{( {r}_{i}^{*} - {μ}_{{ɛ}_{k} , i} )}^{2}}{2 {σ}_{{ɛ}_{k} , i}^{2}} )$$

where, rᵢ* represents the normalized user personalized demand value of the i^{th} demand feature reqᵢ* in order*. Because of the continuity of rᵢ*, the distribution law of probability density function is satisfied, P(rᵢ*|εₖ)˜N(μ_{ε,j},σ_{ε,j}²).

2.4.3 The conditional probability P(order*|εₖ) that the k^{th} module selects different design patterns according to the new order feature vector order* is:

P(order*|εₖ)=Πᵢ₌₁ⁿP(rᵢ*|εₖ)

where, P(order*|εₖ) is determined by the combination of n rᵢ values in order*, based on the assumption of attribute conditional independence.

2.4.4 Based on Bayesian theorem, the user satisfaction probability P(εₖ|order*) when the k^{th} module adopts different design patterns is obtained as:

$$P ( {ɛ}_{k} \vert o r d e {r}^{*} ) = \frac{P ( {ɛ}_{k} ) P ( {order}^{*} \vert {ɛ}_{k} )}{P ( {order}^{*} )}$$

where, 0<P(order*)≤1 indicates an evidence factor, which is a constant; therefore, comparing the value of P(εₖ|order*) means comparing the value of {P(εₖ)·P(order*|εₖ)}, and the design pattern corresponding to the maximum value of {P(εₖ)·P(order*|εₖ)|εₖ=1, 2, 3} is selected as the matching result pₖ*={εₖ|max{P(εₖ)·P(order*|εₖ), εₖ=1, 2, 3}}, 1≤k≤m.

2.5. The feature vectors of each order are calculated and matched in turn to form the final design pattern matching result pattern*={p₁*, p₂*, . . . , pₖ*, . . . , pₘ*}, which can guide the designers to make designs.

3. The designer completes the customized design scheme of the mechanical product, and directly feeds it back to user on the Internet+ design platform, so that the user can experience the product performance and determine whether it meets the demand. If it does not meet the requirements, the scheme will be fed back to the designer in real time to redesign the part that does not meet the requirements; if so, the product design scheme is determined to turn to the manufacturing stage.

According to the present application, the customized design of the mechanical product is carried out on the basis of user orders, and the design is driven by the demand of a single user; and the user participates in the whole design process through the Internet+ design platform, and makes mutual feedbacks with the designer in real time, so that the final design scheme meets the personalized demand of the user. According to the application, three individualized design modes of mechanical products are provided, namely, a configuration design mode according to orders, a deformation design mode according to orders and a generation design mode according to orders, so that the customized design requirements of almost all mechanical products are met. The three design modes effectively alleviate the contradiction between demand individuation and production scale. In the stage of design pattern matching, it is not necessary for designers to determine the module design patterns that meet the order requirements according to experience, and the design efficiency and user satisfaction of design results are improved.

As a highly personalized customized mechanical product, elevators are widely used in daily life. There are great differences in elevator systems in different buildings, so users' demands for elevators are also personalized. An elevator is divided into a drive system, a suspension system, a landing door system, a car system and other systems, each of which can be independently designed and assembled. The car system with the highest degree of personalization is selected as a specific example for explanation.

The implementation process of this method is illustrated with a simplified example. Table 1 is a simplified case library of local elevator design pattern matching, with new personalized order feature vectors order*={(load, 0.54), (scene, 0.25), (speed, 0.61), (floor, 0.45), (decoration, 0.14)}; taking the design pattern matching of a module No. 24 as an example, the specific calculation steps are as follows:

TABLE 1
Case Library of Elevator Design Pattern Matching (Simplified Parts)

| | order | | | | | pattern | | |
|---|---|---|---|---|---|---|---|---|
| No. | load | scene | speed | floor | Decoration | . . . | p₂₄ | . . . |
| 1 | 0.74 | 0.41 | 0.56 | 0.75 | 0 | | 1 | |
| 2 | 0.56 | 0.21 | 0.67 | 0.53 | 0.21 | | 1 | |
| 3 | 0.40 | 0.21 | 0.75 | 0.34 | 0.26 | | 1 | |
| 4 | 0.68 | 0.11 | 0.11 | 0.09 | 0.52 | | 2 | |
| 5 | 0.24 | 0.12 | 0.20 | 0.13 | 0.41 | | 2 | |

$$P ( {ɛ}_{24} = 1 ) = 0.6 , P ( {ɛ}_{24} = 2 ) = 0.4 , P ( {ɛ}_{24} = 3 ) = 0$$

$$P ( load = 0.54 \vert {ɛ}_{24} = 1 ) = \frac{1}{\sqrt{2 π} \times 0.170} exp ( - \frac{{( 0.54 - 0.567 )}^{2}}{2 \times 0.029} ) \approx 2.3167 , \\ P ( load = 0.54 \vert {ɛ}_{24} = 2 ) = \frac{1}{\sqrt{2 π} \times 0.311} exp ( - \frac{{( 0.54 - 0.46 )}^{2}}{2 \times 0.00968} ) \approx 1.2406 , \\ P ( scene = 0.25 \vert {ɛ}_{24} = 1 ) = \frac{1}{\sqrt{2 π} \times 0.1155} exp ( - \frac{{( 0.25 - 0.276 \; 7 )}^{2}}{2 \times 0.0133} ) \approx 3.3640 , \\ P ( load = 0.25 \vert {ɛ}_{24} = 2 ) = \frac{1}{\sqrt{2 π} \times 0.0071} exp ( \frac{{( 0.25 - 0.1150 )}^{2}}{2 \times 5 \times 1 {0}^{- 5}} ) \approx 4 \times 1 {0}^{- 78} , \\ P ( speed = 0.61 \vert {ɛ}_{24} = 1 ) = \frac{1}{\sqrt{2 π} \times 0.0954} exp ( - \frac{{( 0.43 - 0.66 )}^{2}}{2 \times 0.0091} ) \approx 0.2286 , \\ P ( speed = 0.61 \vert {ɛ}_{24} = 2 ) = \frac{1}{\sqrt{2 π} \times 0.0636} exp ( - \frac{{( 0.43 - 0.155 )}^{2}}{2 \times 0.0041} ) \approx 5 \times 1 {0}^{- 4} , \\ P ( floor = 0.45 \vert {ɛ}_{24} = 1 ) = \frac{1}{\sqrt{2 π} \times 0.205 \; 2} exp ( - \frac{{( 0.05 - 0.54 )}^{2}}{2 \times 0.0421} ) \approx 0.1123 , \\ P ( floor = 0.45 \vert {ɛ}_{24} = 2 ) = \frac{1}{\sqrt{2 π} \times 0.0283} exp ( - \frac{{( 0.05 - 0.11 )}^{2}}{2 \times 8 \times 1 {0}^{- 4}} ) \approx 1.4866 , \\ P ( decoration = 0.14 \vert {ɛ}_{24} = 1 ) = \frac{1}{\sqrt{2 π} \times 0.138} exp ( - \frac{{( 0.14 - 0.1567 )}^{2}}{2 \times 0.019} ) \approx 2.8707 , \\ P ( decoration = 0.14 \vert {ɛ}_{24} = 2 ) = \frac{1}{\sqrt{2 π} \times 0.0778} exp ( - \frac{{( 0.14 - 0.465 )}^{2}}{2 \times 0.0061} ) \approx 8.3 \times 1 {0}^{- 4} ,$$

Let P(order*)=1, then P(ε₂₄=1|order*)=0.574, P(ε₂₄=2|order*)=3.06×10⁻⁸⁴, P(ε₂₄=3|order*)=0, therefore, the module No. 24 should use the design pattern of configuration according to orders. The design pattern matching of other modules is calculated in a similar way.

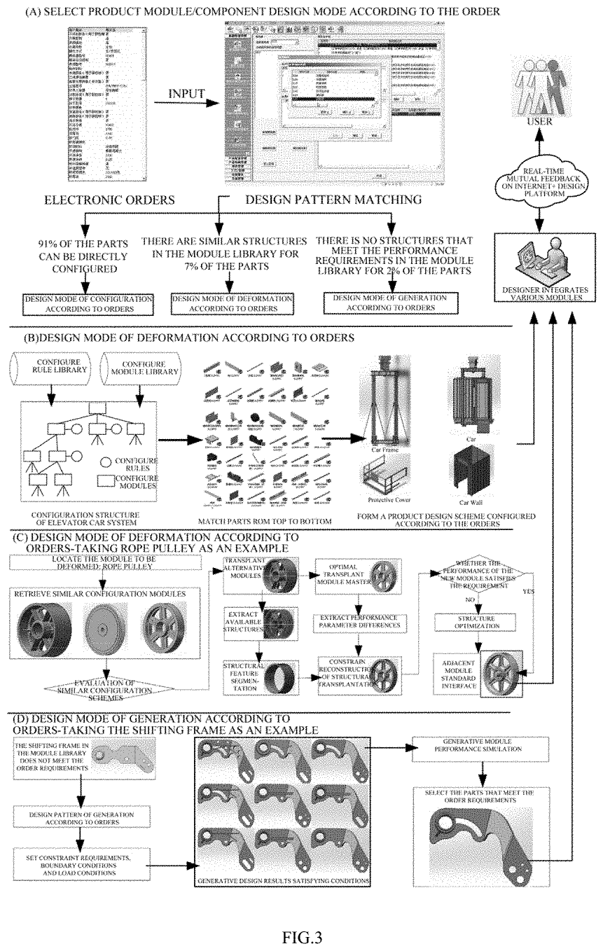

As shown in FIG. 3, it is a process diagram for realizing personalized design of an elevator car system in an Internet+ environment.

(1) The personalized demand put forward by the user under the Internet+ environment is transformed into a new electronic order, and an order feature vector order* of the personalized demand of users is generated by the electronic order. According to the personalized design pattern matching method proposed by the application, the user satisfaction probabilities of three design patterns are calculated one by one according to the divided design modules, and the design pattern matching is carried out. The results show that 91% of the modules adopt the design pattern of configuration according to the orders, 7% adopt the design pattern of deformation according to the orders, and 2% adopt the design pattern of generation according to the orders, as shown in FIG. 3(a).

(2) In the matching result, the design modules such as the car frame, car, protective cover and car wall can be configured according to the orders. Through the existing configuration rule library, the configuration structure of the module library and elevator car system are configured, and the parts that meet the order requirements from top to bottom are matched from the module library to form the specific design scheme of each module configured according to the order, as shown in FIG. 3(b).

(3) According to the design mod of deformation according to orders, the design process is explained by taking a rope pulley as an example. First, similar configuration modules are retrieved from the module library. After evaluating the similar configuration schemes, the optimal transplant master and transplant alternative modules are selected, the available structures are extracted from the transplant alternative modules, the performance parameter differences are extracted from the optimal transplant master, the available structures are transplanted to the master after being divided by structural features, the constraints are reconstructed, and the structure is optimized to meet the order requirements. The interface between the new deformation module and the adjacent modules is standardized, forming the specific design scheme of the rope pulley deformed according to the orders, as shown in FIG. 2(c).

(4) According to the design mode of generation according to orders, the design process is illustrated by taking the shifting frame as an example. After setting constraint conditions, boundary conditions and load conditions according to the order information about the shifting frame, various generative design results meeting the conditions can be obtained according to the design mode of generation according to orders, and the performance simulation is carried out to select the shifting frame design scheme meeting the order requirements, as shown in FIG. 3(d).

(5) FIGS. 3(b)-(d) all take a certain component as an example, and other components are designed one by one according to the design pattern matching results. Finally, the designer integrates various modules, and the user and the designer make real-time mutual feedbacks on the Internet+ design platform, and the designer modifies or redesigns the design results until they fully meet the needs of user.

What is claimed is:

1. A matching method for personalized design patterns of a mechanical product oriented to an Internet+ environment, comprising the following steps:
(1) constructing an order feature vector order of a personalized demand of a user:
order={(req₁,r₁),(req₂,r₂), . . . ,(reqᵢ,rᵢ), . . . ,(reqₙ,rₙ)}
where reqᵢ represents an i^{th} demand feature, rᵢ represents a normalized demand value of the i^{th} demand feature, and n is a number of demand features;
(2) decomposing a mechanical product into m modules d₁˜dₘ and constructing a product decomposition module set D={d₁, d₂, . . . , dₘ},
(3) constructing a design pattern matching case library X according to historical order records of a design pattern scheme that meets the demand of the user:
X={(orderⱼ,patternⱼ)}ⱼ₌₁^{M}
patternⱼ={p₁ⱼ,p₂ⱼ, . . . ,pₖⱼ, . . . ,pₘⱼ}
where M represents a number of historical orders in the design pattern matching case library, orderⱼ represents an order feature vector of a j^{th} order; pₖⱼ represents a design pattern adopted by a k^{th} module in the j^{th} order, patternⱼ represents a design pattern matching result of each module in the j^{th} order, 1≤k≤m;
(4) for a new order feature vector order*, when the k^{th} module of the mechanical product adopts different design patterns, a user satisfaction probability order* being:
$$P ( {ɛ}_{k} \vert o r d e {r}^{*} ) = \frac{P ( {ɛ}_{k} ) P ( o r d e {r}^{*} \vert {ɛ}_{k} )}{P ( o r d e {r}^{*} )}$$
where 0<P(order*)≤1 is a constant; P(εₖ) represents a probability that the k^{th} module in the design pattern matching case library X adopts a design pattern εₖ:
$$P ( {ɛ}_{k} ) = \frac{\vert X ( {ɛ}_{k} ) \vert}{M}$$
where X(εₖ) represents an order set in which the k^{th} module in X adopts the design pattern εₖ, |X(εₖ)| is a number of elements in X(εₖ); P(order*|εₖ) is a conditional probability of selecting different design patterns for the k^{th} module according to the new order feature vector order*:
$$P ( o r d e {r}^{*} \vert {ɛ}_{k} ) = {\prod }_{i = 1}^{n} P ( {r}_{i}^{*} \vert {ɛ}_{k} ) = {\prod }_{i = 1}^{n} \frac{1}{\sqrt{2 π} {σ}_{{ɛ}_{k} , i}} exp ( - \frac{{( {r}_{i}^{*} - {μ}_{{ɛ}_{k} , i} )}^{2}}{2 {σ}_{{ɛ}_{k} , i}^{2}} )$$
where rᵢ* represents a normalized demand value of the i^{th} demand feature in order*, 1≤i≤n; X(εₖ)ᵢ is a set of normalized demand values rᵢ of the i^{th} demand feature in an order where the k^{th} module in X adopts the design pattern εₖ, and μ_{ε}_{ₖ}_{,i}, σ_{ε}_{ₖ}_{,i}² are a mean value and a variance of the set X(εₖ)ᵢ, respectively;
(5) taking the design pattern corresponding to a maximum probability value of P(εₖ|order*) as a design pattern matching result pₖ* of the k^{th} module; wherein comparing a value of {P(εₖ|order*)|εₖ=1, 2, 3} is actually comparing a value of {P(εₖ)P(order*|εₖ)|εₖ=1, 2, 3} since P(order*) is a constant; and
(6) obtaining the design pattern matching results of all modules of the mechanical product to form a final design pattern matching result pattern*={p₁*, p₂*, . . . , pₖ*, . . . , pₘ*}.

2. The matching method for personalized design patterns of a mechanical product oriented to an “Internet+” environment according to claim 1, wherein the design pattern εₖ=1, 2, 3; wherein εₖ=1 represents that the k^{th} module adopts a design pattern of configuration according to orders, εₖ=2 represents that the k^{th} module adopts a design pattern of deformation according to orders, and εₖ=3 means that the k^{th} module adopts a design pattern of generation according to orders.
